(19) United States
(12) Patent Application Publication
(10) Pub. No.: US 2018/0245474 A1
(43) Pub. Date: Aug. 30, 2018

(54) ARRANGEMENT FOR A GAS TURBINE

(71) Applicant: Siemens Aktiengesellschaft, Munich (DE)

(72) Inventor: Varkey Alexander, Nantwich (GB)

(73) Assignee: Siemens Aktiengesellschaft, Munich (DE)

(21) Appl. No.: 15/753,439

(22) PCT Filed: Aug. 5, 2016
(86) PCT No.: PCT/EP2016/068759

§ 371 Date: Feb. 19, 2018

(30) Foreign Application Priority Data
Sep. 10, 2015 (EP) 15184574.0

(51) Int. Cl. F01D 5/30; F01D 5/08

(52) U.S. Cl. CPC F01D 5/3015; F01D 5/087; F05D 2260/30; F05D 2260/20; F05D 2240/55

(57) ABSTRACT

An arrangement for a gas turbine, including: a rotor disk portion comprising an engaging section; a blade unit portion including an engaging section, wherein the respective engaging sections are engaged to circumferentially and radially fix the rotor disk portion and the blade unit portion relative to each other; a locking plate connected to the rotor disk portion and the blade unit portion such as to axially fix the blade unit portion with respect to the rotor disk portion, wherein the locking plate is axially spaced apart by a spacing from an axial end of the engaging portions of the rotor disk portion and/or the blade unit portion leaving a void region axially between the engaging portions and the locking plate.

### CROSS REFERENCE TO RELATED APPLICATIONS

This application is the US National Stage of International Application No. PCT/EP2016/068759 filed Aug. 5, 2016, and claims the benefit thereof. The International Application claims the benefit of European Application No. EP15184574 filed Sep. 10, 2015. All of the applications are incorporated by reference herein in their entirety.

### FIELD OF INVENTION

The present invention relates to an arrangement for a gas turbine and to a gas turbine comprising plural arrangements for a gas turbine. In particular, the present invention relates to an arrangement for a turbine section of a gas turbine and to a gas turbine.

### ART BACKGROUND

A gas turbine comprises a compression section, a combustion section and a turbine section. In the compression section, air is compressed to high pressure and is guided to the combustion section comprising plural combustors that combust fuel in the presence of the compressed air. The combustion products are at high temperature and high pressure and drive plural rotor blades carried at rotor disks, in order to drive a rotation shaft. Due to the high pressure and high temperature, the components of the turbine section of the gas turbine need to be cooled during operation. Conventionally, a cooling fluid, in particular compressed air, that has been compressed by the compressor section is used for cooling. The cooling fluid is guided to the component to be cooled using cooling ducts that are partially provided within some components of the turbine section of the gas turbine. In particular, the rotor disks comprise cooling ducts in order to cool a platform section and/or a rotor blade, in particular by leading cooling air into an inside of the airfoil section of the rotor blade.

In a conventional rotor disk of a turbine section of a gas turbine, a cooling duct may end at a hole at a surface of the rotor disk at a disk root base. The break out point of the hole may be subjected to high stress. Prolonged stress may damage the rotor disk and may limit the lifetime. When the cooling hole or cooling duct breaks out at an angle, the problem may be increased and the acute corner of the breakout region may usually be a life limiting factor.

The European patent application EP 0 814 233 A2 discloses a gas turbine engine rotor disk with cooling fluid passage which are inclined in the downstream direction, wherein each air supply passage has a cross-sectional configuration which renders the ends of the passages less likely than normal to act as the site of hoop-stress induced cracks.

The United States patent U.S. Pat. No. 4,344,738 discloses a rotor disk structure adapted to receive a plurality of coolable rotor blades of a gas turbine engine, wherein tangential stress concentration factors are reduced, wherein the elongated axis of each cooling air hole lies in a plane perpendicular to the axis of symmetry of the disk.

The international application WO 2013/135319 A1 discloses a gas turbine arrangement alleviating stresses at turbine disks and corresponding gas turbine wherein the turbine disk comprises a slot in which a root portion of rotor blade is secured. The root portion of the rotor blade comprises a root bottom comprising a first concave surface section and the slot bottom comprises a first convex surface, wherein the first convex surface section is pierced by an outlet of a cooling duct through the turbine disk.

There may be a need for an arrangement for a gas turbine, in particular an arrangement for a turbine section of a gas turbine, wherein the lifetime of components can be prolonged compared to the prior art. Further, there may be a need for an arrangement for a turbine section of a gas turbine, wherein a reliable and secure operation may be ensured, without damaging components of the gas turbine.

### SUMMARY OF THE INVENTION

This need may be satisfied by the subject-matter of the independent claims which is directed to an arrangement for a gas turbine, in particular an arrangement for a turbine section of a gas turbine. Furthermore, the need may be satisfied with the gas turbine comprising plural arrangements for a turbine section of a gas turbine.

According to an embodiment of the present invention it is provided an arrangement for a gas turbine, comprising a rotor disk portion comprising an engaging section, a blade unit portion comprising an engaging section, wherein the respective engaging sections are engaged to circumferentially and radially fix the rotor disk portion and the blade unit portion relative to each other, a locking plate connected to the rotor disk portion and the blade unit portion such as to axially fix the blade unit portion with respect to the rotor disk portion, wherein the locking plate is axially spaced apart by a spacing from an axial end of the engaging portions of the rotor disk portion and/or the blade unit portion leaving a void region axially between the engaging portions and the locking plate.

The arrangement is in particular for a turbine section of a gas turbine. Thereby, a turbine section of a gas turbine may have a plurality of rows of stationary vanes and rotatable rotor blades. The gas turbine may for example comprise two, three, four or even more rows of stationary vanes and rotatable blades. The blade of each row may be identical to each other and may include an aerofoil section, a platform section and an engaging section. At the aerofoil section, the high pressure high temperature exhaust gas exhausted from the combustors may impact and transfer enthalpy or energy, in order to rotate the blades. The aerofoil section may be secured to the platform portion which in turn may be secured to the engaging section. Some blade rows may additionally include a shroud portion preventing the hot gases escaping over the blade tip.

The blades may be, via the disks, connected to a rotation shaft that rotates around a rotation axis along the axial direction. The radial direction and the circumferential direction are perpendicular to the axial direction. One row of blades may be arranged substantially in a plane or slice perpendicular to the axial direction.

The blade unit portion is considered to represent a portion of a blade unit. A blade unit thereby may comprise the aerofoil section, the platform section and the engaging section. The blade unit thereby may comprise at least a portion of the platform section and a portion of the engaging section. The blade unit portion for example must not or need not to comprise the aerofoil portion and the entire platform section, but may comprise at least a part of the engaging section.

A rotor disk portion may refer to a portion of the rotor disk. The rotor disk may comprise a rim section and an engaging section. The rotor disk may be secured to the rotation shaft. The rotor disk portion may allow to mount at least one blade unit to the rotation shaft. Plural rotor disk portions may be assembled to arrive at a rotor disk extending over a full circumference.

For attaching a blade unit to a rotor disk portion, the blade unit may for example in an axial direction slit into a slot provided by the engaging section of the rotor disk portion. After the respective engaging sections of the rotor disk portion and the blade unit portion are being engaged (thereby for example the engaging sections of the rotor disk portion sandwiching the engaging section of the blade unit portion between them) the respective blade unit may be fixed in the radial and circumferential directions but not be sufficiently fixed in the axial direction.

To provide for this axial fixation, the locking plate is being used. The locking plate may assume any shape or geometry. In particular, the locking plate may comprise a metal sheet having plane surfaces. Other shapes are possible. The locking plate may be formed as a substantially rectangular metal sheet. The locking plate may also provide a seal to prevent cooling air escaping, rather than cooling the desired regions.

The locking plate is connected to the rotor disk portion as well as to the blade unit portion, in order to fix the blade unit portion (and thus the blade unit) in an axial direction relative to the rotor disk (that is fixed at the rotor shaft). The locking plate may for example be connected to the rotor disk portion at a rim section thereof and may be connected to the blade unit portion at a platform portion or section thereof. Different connection means may be employed: For example, the locking plate may be clamped within a recess at the rotor disk portion as well as within a recess at the blade unit portion. In other embodiments the locking plate may have some clearance in these slots to allow for expansion or misalignment. The locking plate may be curved so that they can be flexed and when put in place into the recess they may straighten and lock in place. In another embodiment, the locking plate may have tabs that when hit engage in a slot (or recess) in the disc to lock them in the circumferential direction. In still another embodiment the locking plate may be bigger in the radial direction so that it may fit in a slot (recess) in the rotor disc that accommodates the bigger size and may not allow circumferential movement.

The locking plate may in particular slit in a circumferential direction into respective recesses provided at the rotor disk portion and the blade unit portion. Thereby, the recesses may substantially run in the circumferential direction and may form e.g. a straight (or partly curved) groove.

The locking plate, at the axial end of the engaging section of the rotor disk portion and/or the blade unit portion, does not touch the axial end of the engaging sections along most of its length, but is axially shifted away from the axial end of the engaging sections of the rotor disk portion and/or the blade unit portion, to leave a void volume or void room between the locking plate and the axial end of the engaging portions. By the thereby provided extended dimension of the rim section of the rotor disk portion and the extended dimension of the platform section of the blade unit it is enabled to design and provide a disk cooling duct running substantially in the radial direction, thereby reducing stress at a breakout hole from the rotor disk portion. At the same time, a reliable secure fixation of the rotor disk portion and the blade unit portion in the axial direction is ensured. Further, any weight increase is limited due to the void region.

The engaging section of the blade unit portion may be the most radial inward section of the blade unit. The engaging section of the rotor disk portion may be the most radial outward section of the rotor disk portion. The engaging sections may be formed by plural lobes and fillets alternating in the radial direction. The basic design of the engaging sections may be as disclosed in WO 2013/135319 A1.

By the claimed subject-matter, a cavity between a turbine blade locking plate and the turbine blade may be created, to allow a more perpendicular disk cooling hole. Thereby, the lifetime of components of the wind turbine, in particular the rotor disk may be prolonged and a reliable operation may be ensured. In particular, according to an embodiment of the present invention, the gap between the turbine blade and the locking plate may be increased (by moving the locking plate away from the blade) compared to the prior art. This may create a cavity that a disk cooling hole can break out into, at a reduced angle. This design may achieve a reduced cooling hole breakout angle with little additional “dead weight”.

According to an embodiment, the blade unit portion comprises a platform section coupled to the engaging section of the blade unit portion, wherein the platform section comprises a recess for receiving an edge of the locking plate and/or comprises a mounting means for mounting the edge of the locking plate to the blade unit portion, wherein the recess and/or the mounting means is located axially spaced apart from the axial end of the engaging portion of the blade unit portion substantially by the spacing.

The platform section of the blade unit portion may be considered as a base structure onto which the aerofoil section of the blade unit is mounted. The platform section may in particular be between the aerofoil section and the engaging section of the blade unit. The recess at the platform section of the blade unit portion may substantially comprise or be a groove extending in the circumferential direction. The edge of the locking plate received within the recess may be a straight edge. The edge may be clamped within the recess by some kind of bias or may be fixed using additional mounting means, such as a tab on the locking plate pressed into a complimentary depression in the disc to fix the locking plate in the circumferential direction, or other. The recess may provide a simple and effective mechanism to connect the locking plate at the blade unit portion.

According to an embodiment of the present invention, the rotor disk portion comprises a rim section coupled to the engaging section of the rotor disk portion, wherein the rim section comprises a recess for receiving another edge of the locking plate and/or a mounting means for mounting the other edge of the locking plate to the rotor disk portion, wherein the recess and/or the mounting means is located axially spaced apart from the axial end of the engaging portion of the rotor disk portion substantially by the spacing.

The rim section of the rotor disk portion may be immediately radially inwards adjacent to the engaging section of the rotor disk portion. The recess at the rim section of the rotor disk portion may substantially be a groove running in the circumferential direction. In the recess at the rim section of the rotor disk portion, a radially inward edge (i.e. the other edge) of the locking plate may be accompanied and mounted and at the recess at the platform section of the blade unit, a radially outward edge (i.e. the edge) of the locking plate may be accompanied and mounted. The recess at the rim section of the rotor disk portion may be located radially inwards from the recess at the platform section of the blade unit portion, their radial distance being substantially the radial extent of the locking plate. Thereby, a simple mechanism for connecting the locking plate to the rotor disk portion may be provided.

According to an embodiment of the present invention, the blade unit portion and/or the rotor disk portion may comprise supporting material to brace the locking plate, the supporting material in particular forming at least a part of the mounting means, the supporting material being provided adjacent to the respective recess of the blade unit portion and/or rotor disk portion, wherein due to the supporting material the void region is narrowed such that the radial extent of the void region is smaller than the radial extent of the engaging portion of the blade unit portion and/or the rotor disk portion. The supporting material is optional, in some embodiments it is not present or used.

The supporting material may be provided on the rotor disk portion alone, on the blade unit portion alone or on the rotor disk portion as well as on the blade unit portion. The additional material may brace the locking plate to prevent vibration or buckling under the gas load. The weight of the supporting material should be kept as low as possible, in order not to interfere with the operation of the turbine and maintain efficiency. Using the supporting material, the locking plate may further be enforced, thereby leading to a reliable fixation of the rotor disk portion and the blade unit portion in the axial direction.

According to an embodiment of the present invention, the spacing has an axial extent of 0% to 45%, in particular 10% to 25%, of an axial extent of the engaging portion of the rotor disk portion and/or the blade unit portion. The spacing may be chosen such that an exit hole of a disk cooling duct may be positioned such that the cooling duct substantially runs in the radial direction. The spacing by which the locking plate is axially spaced apart from the axial ends of the engaging sections of the rotor disk portion and/or the blade unit portion may amount e.g. to between 5 mm and 20 mm, but other values are possible depending on the size of the gas turbine.

According to an embodiment of the present invention, the void region (in particular if no supporting additional material for reinforcement is provided) extends radially and/or circumferentially over an entire respective extent of the engaging portion of the rotor disk portion and/or the blade unit portion. By having a relatively large void region, the weight of the arrangement may be limited, thereby maintaining the efficiency of the gas turbine and reducing the size and cost of the disc.

According to an embodiment of the present invention, within the rotor disk portion, a disk cooling duct is formed, running in a disk cooling duct direction having an axial component between 0% and 20% of a radial component, in particular having a circumferential component between 0% and 10% of a radial component.

The disk cooling duct may run in an interior of the rotor disk portion, in particular in the interior of the rotor disk part which is provided for attaching thereto one blade unit. The disk cooling duct may be a through-hole through the rotor disk portion. Cooling fluid, in particular compressed air (colder than the components to be cooled, in particular taken directly from the compressor), may be guided through the disk cooling duct radially outwards in order to cool components of the blade unit. The disk cooling duct direction may be defined as a curve comprised of the cross-sectional centers of the disk cooling duct. In other embodiments, the disk cooling duct direction may be defined as the direction of cooling fluid streaming through the disk cooling duct. The disk cooling duct direction may be described in a polar coordinate system having as axis the axial direction, the radial direction and the circumferential direction. In particular, the disk cooling duct direction may have relatively small or no component in the axial direction and a relatively small or no component in the circumferential direction. Thereby, stress at a radially outer exit of the disk cooling duct at a rim portion of the rotor disk portion may be reduced compared to the prior art. In particular, the component in the axial direction should be kept relatively small in order to reduce stress.

According to an embodiment of the present invention, the rotor disk portion comprises a radially outer exit of the disk cooling duct at a rim portion of the rotor disk portion, wherein the disk cooling duct direction is substantially radially oriented at least at the radially outer exit.

The disk cooling duct direction may vary or change along a longitudinal extent of the disk cooling duct or may be substantially constant along the longitudinal direction of the disk cooling duct. At least close to the radially outer exit of the disk cooling duct, the disk cooling duct direction should be substantially radially directed, in order to reduce the stress at the radially outer exit. When the disk cooling duct is straight, manufacturing the disk cooling duct may be simplified.

According to an embodiment of the present invention, a surface of the rim portion of rotor disk portion at the radially outer exit is substantially perpendicular to the disk cooling duct direction close to the radially outer exit. The surface of the rim portion of the rotor disk portion should be substantially perpendicular to the disk cooling duct direction close to the exit, in particular the radially outer exit, in order to reduce the stress at the radially outer exit.

According to an embodiment of the present invention, the radially outer exit at least partially overlaps axially with the void region and/or at least partially overlaps axially with the engaging section of the blade unit portion.

The void region may therefore be partially filled with cooling fluid and the cooling fluid may be discharged from the void region by providing additional cooling ducts within the blade unit portion. Thereby, cooling of the blade may be ensured.

According to an embodiment of the present invention, the radially outer exit does not overlap with the void region. In this case, the radially outer exit may for example be aligned or may lead into a blade cooling duct.

According to an embodiment of the present invention, the engaging section of the blade unit portion comprises a blade cooling duct at an axial position to be in communication with the disk cooling duct, to allow cooling fluid to pass through the disk cooling duct and then through the blade cooling duct, in order to enable cooling an inside of the blade and/or cooling a platform section of the blade to cool the root. The blade cooling duct may or may not align to the disc cooling duct. It may be conventionally known to have a blade cooling duct within the engaging section of the blade unit portion. The blade cooling duct may allow to cool portions of the blade. Thereby, a reliable operation may be ensured.

According to an embodiment of the present invention, a thickness of the locking plate in the axial direction amounts to 1% to 10% of an axial extent of the engaging portion of the rotor disk portion and/or the blade unit portion. The thickness of the locking plate may be chosen depending on the application and in particular depending on the spacing. The larger the spacing, the bigger the thickness of the locking plate may be chosen.

According to an embodiment of the present invention, the engaging portions each comprise lobes and fillets (being complementary to each other) alternating in the radial direction, in particular each forming a structure resembling a firtree.

The geometry and design of the engaging portions may essentially be similar or identical to the engaging portions as disclosed in WO 2013/1353198 A1. Thereby, a reliable fixation in the radial and circumferential direction may be ensured and a simple mounting may be enabled.

According to an embodiment of the present invention, the arrangement further comprises another locking plate connected to the rotor disk portion and the blade unit portion such as to further axially fix the blade unit portion with respect to the rotor disk portion, wherein the other locking plate is axially located at another axial end of the engaging portions of the rotor disk portion and/or the blade unit portion without leaving a void region axially between the engaging portions and the other locking plate.

The other locking plate may be assembled in a conventional manner and may also be located as is known in the prior art. Only one blade cooling duct and only one corresponding rotor disk cooling duct may be provided per blade unit. Thus, at the other axial end of the engaging portions, no provisions are necessary in order to orient another cooling duct substantially in the radial direction.

According to an embodiment of the present invention it is further provided a gas turbine that comprises a rotor disk and plural blade units attached to the rotor disk, thereby employing plural arrangements as described in one of the above embodiments.

Furthermore, according to an embodiment of the present invention, a rotor disk arrangement for a turbine section of a gas turbine is provided that comprises a rotor disk and plural blade units attached to the rotor disk. Each blade unit comprises a blade unit portion and the rotor disk comprises plural rotor disk portions as comprised in the arrangement for a turbine section of a gas turbine as described in one of the above embodiments. Furthermore, to each blade unit or to a number of blade units, a corresponding locking plate may associated as is specified in one of the above embodiments. In some embodiments to exactly one blade unit exactly one locking plate may be associated. In other embodiments one locking plates can overlap several blade units so that one locking plate may span more than one blade or part of two blades, or one blade completely and part of two blades etc. Other configurations are possible.

It has to be noted that embodiments of the invention have been described with reference to different subject matters. In particular, some embodiments have been described with reference to method type claims whereas other embodiments have been described with reference to apparatus type claims. However, a person skilled in the art will gather from the above and the following description that, unless other notified, in addition to any combination of features belonging to one type of subject matter also any combination between features relating to different subject matters, in particular between features of the method type claims and features of the apparatus type claims is considered as to be disclosed with this document.

The aspects defined above and further aspects of the present invention are apparent from the examples of embodiment to be described hereinafter and are explained with reference to the examples of embodiment. The invention will be described in more detail hereinafter with reference to examples of embodiment but to which the invention is not limited.

### BRIEF DESCRIPTION OF THE DRAWINGS

Embodiments of the present invention are now described with reference to the accompanying drawings. The invention is not restricted to the illustrated or described embodiments.

FIG. 1 schematically illustrates in a sectional view including the rotation axis a gas turbine engine according to an embodiment of the present invention;

FIG. 2 schematically illustrates in a cross-sectional view as viewed along the circumferential direction an arrangement for a turbine section of a gas turbine according to an embodiment of the present invention; and

FIG. 3 schematically illustrates in a cross-sectional view as viewed along the circumferential direction an arrangement for a turbine section of a gas turbine according to an embodiment of the present invention.

### DETAILED DESCRIPTION

The illustration in the drawings is in schematic form. It is noted that in different figures, similar or identical elements are provided with the same reference signs or with reference signs, which are different from the corresponding reference signs only within the first digit.

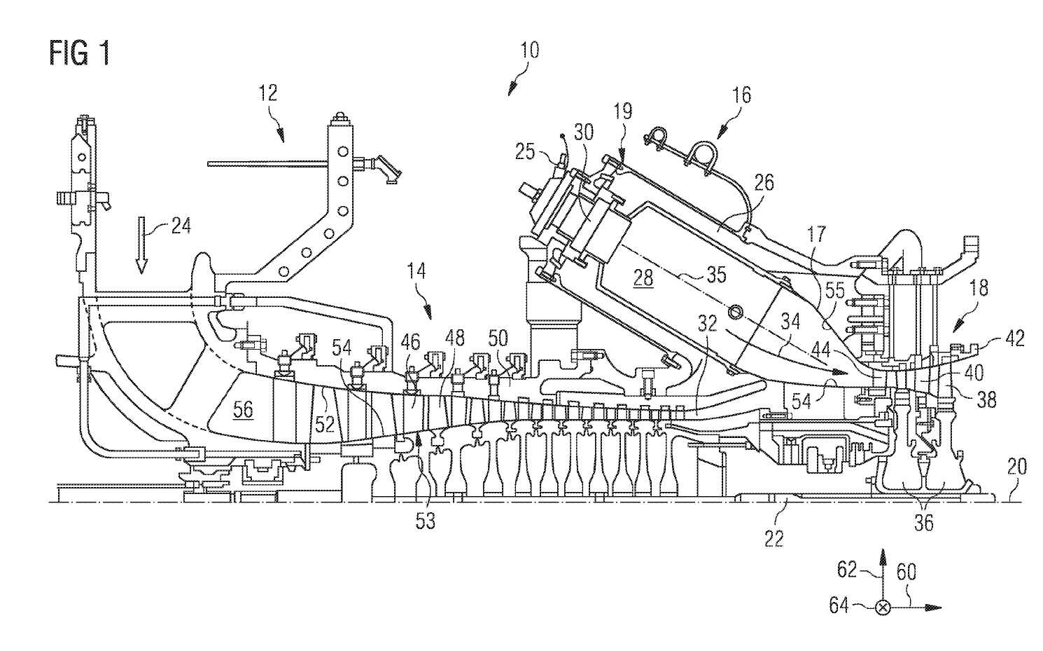

In FIGS. 1, 2 and 3, the axial direction is labelled with reference sign 60, the radial direction is labelled with reference sign 62 and the circumferential direction is labelled with reference sign 64.

FIG. 1 shows an example of a gas turbine engine 10 in a sectional view. The gas turbine engine 10 comprises, in flow series, an inlet 12, a compressor section 14, a combustor section 16 and a turbine section 18 which are generally arranged in flow series and generally about and in the direction of a longitudinal or rotational axis 20. The gas turbine engine 10 further comprises a shaft 22 which is rotatable about the rotational axis 20 and which extends longitudinally through the gas turbine engine 10. The shaft 22 drivingly connects the turbine section 18 to the compressor section 14.

In operation of the gas turbine engine 10, air 24, which is taken in through the air inlet 12 is compressed by the compressor section 14 and delivered to the combustion section or burner section 16. The burner section 16 comprises a burner plenum 26, one or more combustion chambers 28 and at least one burner 30 fixed to each combustion chamber 28. The combustion chambers 28 and the burners 30 are located inside the burner plenum 26. The compressed air passing through the compressor 14 enters a diffuser 32 and is discharged from the diffuser 32 into the burner plenum 26 from where a portion of the air enters the burner 30 and is mixed with a gaseous or liquid fuel. The air/fuel mixture is then burned and the combustion gas 34 or working gas from the combustion is channelled through the combustion chamber 28 to the turbine section 18 via a transition duct 17.

This exemplary gas turbine engine 10 has a cannular combustor section arrangement 16, which is constituted by an annular array of combustor cans 19 each having the burner 30 and the combustion chamber 28, the transition duct 17 has a generally circular inlet that interfaces with the combustor chamber 28 and an outlet in the form of an annular segment. An annular array of transition duct outlets form an annulus for channelling the combustion gases to the turbine 18.

The turbine section 18 comprises a number of blade carrying discs 36 attached to the shaft 22. In the present example, two discs 36 each carry an annular array of turbine blades 38. However, the number of blade carrying discs could be different, i.e. only one disc or more than two discs. In addition, guiding vanes 40, which are fixed to a stator 42 of the gas turbine engine 10, are disposed between the stages of annular arrays of turbine blades 38. Between the exit of the combustion chamber 28 and the leading turbine blades 38 inlet guiding vanes 44 are provided and turn the flow of working gas onto the turbine blades 38.

The combustion gas from the combustion chamber 28 enters the turbine section 18 and drives the turbine blades 38 which in turn rotate the shaft 22. The guiding vanes 40, 44 serve to optimise the angle of the combustion or working gas on the turbine blades 38.

The turbine section 18 drives the compressor section 14. The compressor section 14 comprises an axial series of vane stages 46 and rotor blade stages 48. The rotor blade stages 48 comprise a rotor disc supporting an annular array of blades. The compressor section 14 also comprises a casing 50 that surrounds the rotor stages and supports the vane stages 48. The guide vane stages include an annular array of radially extending vanes that are mounted to the casing 50. The vanes are provided to present gas flow at an optimal angle for the blades at a given engine operational point. Some of the guide vane stages have variable vanes, where the angle of the vanes, about their own longitudinal axis, can be adjusted for angle according to air flow characteristics that can occur at different engine operations conditions.

The casing 50 defines a radially outer surface 52 of the passage 56 of the compressor 14. A radially inner surface 54 of the passage 56 is at least partly defined by a rotor drum 53 of the rotor which is partly defined by the annular array of blades 48.

The present invention is described with reference to the above exemplary turbine engine having a single shaft or spool connecting a single, multi-stage compressor and a single, one or more stage turbine. However, it should be appreciated that the present invention is equally applicable to two or three shaft engines and which can be used for industrial, aero or marine applications.

The terms upstream and downstream refer to the flow direction of the airflow and/or working gas flow through the engine unless otherwise stated. The terms forward and rearward refer to the general flow of gas through the engine. The terms axial, radial and circumferential are made with reference to the rotational axis 20 of the engine.

The turbine section 18 includes two rows of disks 36 to which rotor blades 38 are attached. Each row of the row of disks 36 having attached the blades 38 comprises plural rotor disk portions each having one blade unit attached. The rotor disk portions are configured according to an arrangement for a gas turbine according to an embodiment of the present invention, wherein the rotor disk portion is connected to a blade unit portion partly using a locking plate according to an embodiment of the present invention.

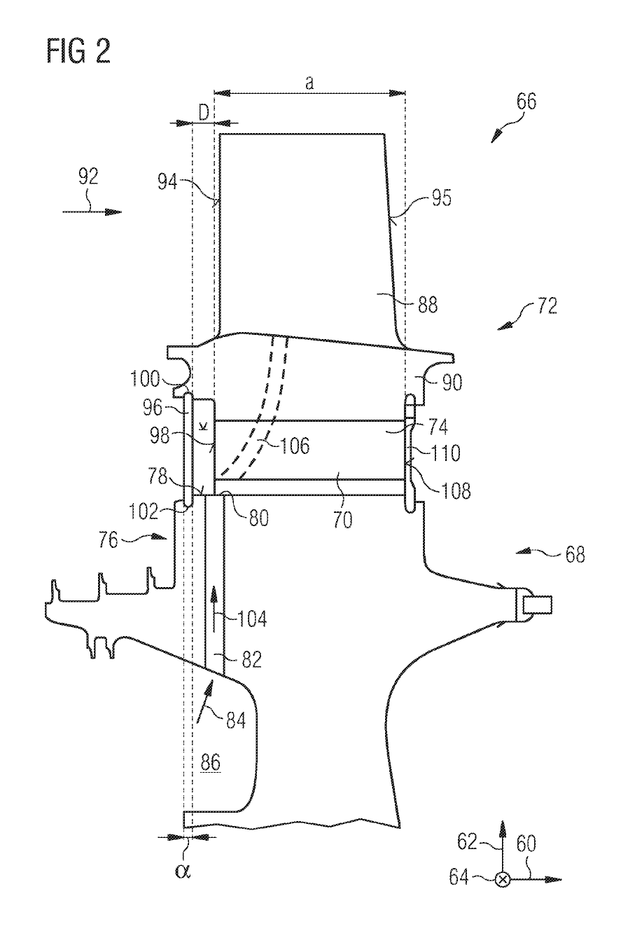

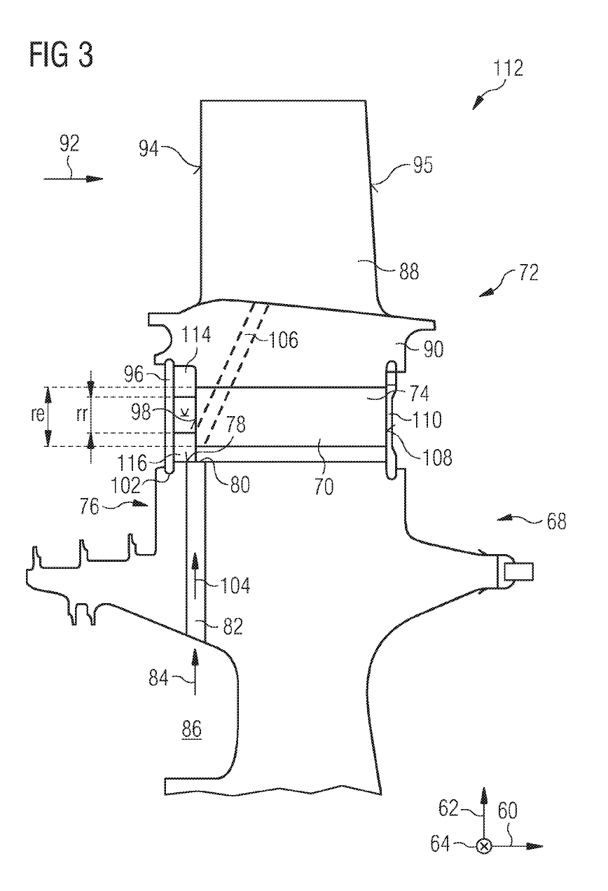

An arrangement for a turbine section 18 of a gas turbine 10 which is comprised in the gas turbine 10 illustrated in FIG. 1 is schematically illustrated in a cross-sectional view in FIG. 2 and another embodiment is schematically illustrated in a cross-sectional view in FIG. 3.

The arrangement 66 for a gas turbine according to an embodiment of the present invention illustrated in FIG. 2 comprises a rotor disk portion 68 comprising an engaging section 70 and further comprises a blade unit portion 72 also comprising an engaging portion 74. Hereby, it should be noted that the engaging portion 70 of the rotor disk portion 68 is circumferentially in another position than the engaging section 74 of the blade unit portion 72. The engaging portions 70, 74 may substantially be formed in a firtree configuration, as is known in the art. The respective engaging sections 70, 74 are engaged to circumferentially and radially fix the rotor disk portion 68 and the blade unit portion 72 to each other.

Thereby, the rotor disk portion 68 comprises a rim portion 76 having a surface 78 on which surface a radially outer exit 80 of a rotor disk cooling duct 82 is located. The rotor disk cooling duct 82 goes through the rotor disk portion 68, in order to allow compressed air 84 (colder than the components to be cooled) provided to a cavity 86 to be guided through the rotor disk cooling duct 82 and to be guided to components of the blade unit portion 72, in order for example to cool an inside of an aerofoil portion 88 of the blade unit portion 72.

The blade unit portion comprises, besides the engaging section 74, a platform section 90 to which an aerofoil section 88 is attached. High pressure hot combustion discharge gas 92 impacts on a leading edge 94 and on surfaces of the aerofoil section 88 of the blade unit portion 72 or the blade unit. The blade unit portion 72 does not need to comprise also the aerofoil section 88, but the entire blade unit comprises the aerofoil section 88, the platform section 90 as well as the engaging section 74.

The arrangement 66 further comprises a locking plate 96 substantially running in the radial direction 62 (and extending in the circumferential direction 64) that connects the rotor disk portion 68 and the blade unit portion 72 such as to axially (i.e. in the axial direction 60) fix the blade unit portion 72 with respect to the rotor disk portion 68. Thereby, the locking plate 96 is axially spaced apart by a spacing D from an axial end 98 of the engaging section 70 and/or 74 of the rotor disk portion 68 and/or the blade unit portion 72. Thereby, a void region V is created axially between the engaging portions 70, 74 and the locking plate 96.

The locking plate 96 is fixed or mounted at the platform section 90 of the blade unit portion 72 within a recess 100 running substantially in the circumferential direction 64, thereby forming a groove. The locking plate may further be mounted at the platform section 90 of the blade unit portion 72 using any mounting means. Also the recess 100 is spaced apart from the axial end 98 of the engaging portions 70, 74 substantially by the spacing D.

The locking plate 96 is, at another radially inner edge of the locking plate 96 mounted at the rotor disk portion 68 in another recess 102, also running substantially in the circumferential direction. The recess is arranged at a rim section 76 of the rotor disk portion 68. Also the recess 102 of the rotor disk portion 68 is axially spaced apart by the spacing D from the axial end 98 of the engaging portions 70, 74.

The disk cooling duct 82 runs in a disk cooling duct direction 104 being substantially oriented along the radial direction 62. Thereby, a stress at the radially outer exit 80 of the disk cooling duct 82 can be reduced. The surface 78 of the rim portion 76 is substantially perpendicular to the disk cooling duct direction 104.

As can be appreciated from FIG. 2, the radially outer exit 80 partially overlaps axially with the void region V. Nevertheless the radially outer exit 80 allows communication to a blade cooling duct 106 exemplary illustrated within the engaging portion 74 of the blade unit portion 72. In other embodiments, the radially outer exit 80 may be aligned with and may allow communication to (e.g. an entrance of) a blade cooling duct 106 exemplary illustrated within the engaging portion 74 of the blade unit portion 72. In other embodiments, the blade cooling duct 106 may be at another axial location or there a blade cooling hole or duct may be missing.

The aerofoil section 88 may be hollow and may be cooled from inside by leading cooling air through the rotor disk cooling duct 104, the blade cooling duct 106 through the platform section 90 into an inside of the aerofoil section 88. In other embodiments, at least the platform section 90 may be cooled via the rotor disk cooling duct 104 and the blade unit cooling duct 106.

The thickness d of the locking plate may be 1 to 10% of an axial extent of (one of) the engaging portions 70, 74 of the rotor disk portion 68 and/or the blade unit portion 72. The spacing d may amount to between 0% and 45 of (one of) the axial extent of the engaging portions 70, 74. Other values are possible.

The engaging portion 70, 74, may comprise alternating lobes and fillets being arranged complementary to each other.

At another axial end 108, another locking plate 110 is arranged connecting the rotor disk portion 72 (in particular at the platform section 90) with the rotor disk portion 68 (in particular at the rim portion 76). The other locking plate 110 is axially arranged immediately adjacent to the axial end 108 of the engaging portions 70, 74 such as to physically contact the axial end 108 of the engaging portions 70, 74.

FIG. 3 schematically illustrates another embodiment of an arrangement for a turbine section of a gas turbine according to an embodiment of the present invention.

Features in common to the embodiments illustrated in FIGS. 2 and 3 are labelled with the same reference signs. Different from the embodiment illustrated in FIG. 2, the embodiment of the arrangement 112 illustrated in FIG. 3 supporting material 114, 116 is arranged adjacent to respective recesses 100 and 102, in particular to decrease the void region V and to support the locking plate 96. The additional material 114 touches to an inward surface of the locking plate 96 but is not attached to it. The additional material 114 is attached to the blade unit portion 72 and/or the rotor disk portion 68. The additional or supporting material 116 is at a radially inward location also attached to an inward surface of the locking plate and is further attached to the rim section 76 of the rotor disk portion 68. Due to the supporting material 114, 116 radial extent rr of the void region V is smaller than the radial extent re of the engaging portions 70, 74.

An advantage of embodiments of the present invention is that the locking plate arrangement allows for reduction in disk cooling hole break out angle, in order to reduce stress at the radially outer exit 80. The additional material 114, 116 can be used to brace the locking plate 96.

In the embodiment illustrated in FIGS. 1 and 2, the locking plate 96 is spaced apart by the spacing on the leading edge 94 or at the side corresponding to the leading edge 94. In other embodiments, the locking plate may be spaced apart by the spacing at the trailing edge 95 or at the side of the trailing edge 95. Thus, the positioning of the locking plate 96 and the other locking plate 110 with respect to the axial ends of the engaging portion 70, 74 could be reversed in other embodiments as compared to the illustrated embodiments illustrated in FIGS. 2 and 3.

It should be noted that the term “comprising” does not exclude other elements or steps and “a” or “an” does not exclude a plurality. Also elements described in association with different embodiments may be combined. It should also be noted that reference signs in the claims should not be construed as limiting the scope of the claims.

### List of Reference Signs:

10 gas turbine engine

12 inlet

14 compressor section

16 combustor section

17 transition duct

18 turbine section

20 rotational axis

22 shaft

24 air

26 burner plenum

28 combustion chamber

30 burner

32 diffuser

34 combustion gas

36 rotor disk

38 turbine blade

40 guiding vane

42 stator

46 vane stage

48 rotor blade stage

50 casing

52 outer surface

56 passage

60 axial direction

62 radial direction

64 circumferential direction

66,112 arrangements for a gas turbine

68 rotor disk portion

72 blade unit portion

74,70 engaging portions

76 rim section

78 surface of rim section

80 radially outer exit

82 rotor disk cooling duct

84 cooling air

86 cavity

88 aerofoil section

90 platform section

92 combustion gas

94 leading edge

95 trailing edge

96 locking plate

98 axial end of engaging portions

100,102 recess

108 other axial end

110 other locking plate

104 rotor disk cooling duct direction

106 blade cooling duct

114,116 supporting material

V void region

D spacing

d thickness

a axial extent of engaging portions

1. An arrangement for a gas turbine, comprising:
a rotor disk portion comprising an engaging section;
a blade unit portion comprising an engaging section,
wherein the respective engaging sections are engaged to circumferentially and radially fix the rotor disk portion and the blade unit portion relative to each other;
a locking plate connected to the rotor disk portion and the blade unit portion such as to axially fix the blade unit portion with respect to the rotor disk portion,
wherein the locking plate is axially spaced apart by a spacing (D) from an axial end of the engaging portions of the rotor disk portion and/or the blade unit portion leaving a void region (V) axially between the engaging portions and the locking plate,
wherein the locking plate comprises a metal sheet having plane surfaces,
wherein the void region (V) extends radially over an entire respective extent of the engaging portion of the rotor disk portion and the blade unit portion,
wherein within the rotor disk portion a disk cooling duct is formed, running in a disk cooling duct direction having an axial component between 0% and 20% of a radial component,
wherein the rotor disk portion comprises a radially outer exit of the disk cooling duct at a rim portion of the rotor disk portion,
wherein the disk cooling duct direction is substantially radially oriented at least at the radially outer exit,
wherein the radially outer exit at least partially overlaps axially with the void region (V).

2. The arrangement according to claim 1,
wherein the blade unit portion comprises a platform section coupled to the engaging section of the blade unit portion,
wherein the platform section comprises a recess for receiving an edge of the locking plate and/or comprises a mounting means for mounting the edge of the locking plate to the blade unit portion,
wherein the recess and/or the mounting means is located axially spaced apart from the axial end of the engaging portion of the blade unit portion substantially by the spacing (D).

3. The arrangement according to claim 1,
wherein the rotor disk portion comprises a rim section coupled to the engaging section of the rotor disk portion,
wherein the rim section comprises a recess for receiving another edge of the locking plate and/or comprises a mounting means for mounting the other edge of the locking plate to the rotor disk portion,
wherein the recess and/or the mounting means is located axially spaced apart from the axial end of the engaging portion of the rotor disk portion substantially by the spacing (D).

4. The arrangement according to claim 2,
wherein the blade unit portion and/or the rotor disk portion comprises supporting material to brace the locking plate,
the supporting material being provided adjacent to the respective recess of the blade unit portion and/or rotor disk portion,
wherein due to the supporting material the void region is narrowed such that the radial extent (rv) of the void region is smaller than the radial extent (re) of the engaging portion of the blade unit portion and/or the rotor disk portion.

5. The arrangement according to claim 1,
wherein the spacing (D) has an axial extent of larger than 0% to 45% of an axial extent (a) of the engaging portion the rotor disk portion and/or the blade unit portion.

6. The arrangement according to claim 1,
wherein the void region (V) extends circumferentially over an entire respective extent of the engaging portion of the rotor disk portion and/or the blade unit portion.

7. The arrangement according to claim 1,
wherein the disk cooling duct direction has a circumferential component between 0% and 10% of a radial component.

8. The arrangement according to claim 1,
wherein a surface of the rim portion of rotor disk portion at the radially outer exit is substantially perpendicular to the disk cooling duct direction close to the radially outer exit.

9. The arrangement according to claim 1,
wherein the radially outer exit at least partially overlaps axially with the engaging section of the blade unit portion.

10. The arrangement according to claim 1,
wherein the engaging section of the blade unit portion comprises a blade cooling duct at an axial position to be in communication with the disk cooling duct, to allow cooling fluid to pass through the disk cooling duct and then through the blade cooling duct, in order to enable cooling an inside of an aerofoil section and/or cooling a platform section of the blade unit portion.

11. The arrangement according to claim 1,
wherein a thickness (d) of the locking plate in the axial direction amounts to 1% to 10% of an axial extent (a) of the engaging portion of the rotor disk portion and/or the blade unit portion.

12. The arrangement according to claim 1,
wherein the engaging portions each comprise lobes and fillets alternating in the radial direction, in particular each forming a structure resembling a firtree being complementary to each other.

13. The arrangement according to claim 1, further comprising:
another locking plate connected to the rotor disk portion and the blade unit portion such as to further axially fix the blade unit portion with respect to the rotor disk portion,
wherein the other locking plate is axially located at another axial end of the engaging portions of the rotor disk portion and/or the blade unit portion without leaving a void region axially between the engaging portions and the other locking plate.

14. A gas turbine, comprising:
a rotor disk;
plural blade units attached to the rotor disk, employing plural arrangements according to claim 1.

15. The arrangement according to claim 4,
wherein the supporting material forms at least a part of the mounting means.

16. The arrangement according to claim 5,
wherein the spacing (D) has an axial extent of larger than 10% to 25%, of an axial extent (a) of the engaging portion of the rotor disk portion and/or the blade unit portion.

17. The arrangement according to claim 12,
wherein the engaging portions each comprise lobes and fillets alternating in the radial direction, each forming a structure resembling a firtree being complementary to each other.
